(19) United States
(12) Patent Application Publication
(10) Pub. No.: US 2022/0292451 A1
(43) Pub. Date: Sep. 15, 2022

(54) ASSET TRACKING, MONITORING, AND MANAGEMENT SYSTEM AND METHODS OF USE

(71) Applicant: Utility Control & Equipment Corporation, Arvada, CO (US)

(72) Inventors: Garrod W. Massey, Denver, CO (US); Mark S. Inboden, Greenwood Village, CO (US)

(21) Appl. No.: 17/693,215

(22) Filed: Mar. 11, 2022

Related U.S. Application Data
(60) Provisional application No. 63/159,751, filed on Mar. 11, 2021.

(51) Int. Cl. G06Q 10/08; H04W 4/029; H04W 4/35; H04W 4/38; H04W 4/80; G06K 19/06

(52) U.S. Cl. CPC G06Q 10/0833; G06Q 10/0832; H04W 4/029; H04W 4/35; H04W 4/38; H04W 4/80; G06K 19/06009

(57) ABSTRACT

There are disclosed systems and methods for location tracking and health monitoring of portable assets. In an embodiment, a tracking and monitoring unit is affixed to the portable asset and has an enclosure housing a microcontroller coupled with a plurality of state sensors, an interrogation tag, and a multi-mode communication system. The microcontroller collects raw data representing a location and a health of the portable asset from the multi-mode communication system and the plurality of the state sensors. An analysis platform receives the raw data from the tracking and monitoring unit and executes a tracking, monitoring, and management module to analyze the raw data according to a plurality of user-defined conditions and, in turn, determine one or more corresponding outcomes, which are presented upon one or more user devices via one or more interactive screens of a tracking and monitoring application implemented by an application-linking platform. Other embodiments are disclosed.

Reference To Pending Prior Patent Application

This application claims the benefit under 35 U.S.C. 119 (e) of U.S. Provisional Patent Application No. 63/159,751, filed Mar. 11, 2021 by Garrod W. Massey, et al., for “ASSET TRACKING, MONITORING, AND MANAGEMENT SYSTEM AND METHODS OF USE” which patent application is hereby incorporated herein by reference.

### BACKGROUND

In the world of logistics, there is a desire to track the location and monitor the health of portable assets including, for example, shipping containers, cargo containers, and portable storage containers along with their contents. Existing asset tracking systems are generally limited to location tracking and lack health monitoring capabilities and/or team, fleet, and customer management capabilities that are desirable in a wholistic approach to asset tracking and management. Further, the asset-location functionality of existing systems is generally provided via GPS sensing only, which is vulnerable to periodic signal losses and location granularity issues as the asset moves about the world. Existing systems exhibit additional challenges with power/battery performance, customized configurability, and cost.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

One embodiment provides a system for tracking a location and monitoring a health of a portable asset. The system may include: (1) a tracking and monitoring unit affixed to the portable asset, the tracking and monitoring unit comprising an enclosure housing a microcontroller communicatively coupled with a plurality of state sensors, an interrogation tag, and a multi-mode communication system including a plurality of communication transceivers, the microcontroller configured for collecting raw data from the multi-mode communication system and the plurality of the state sensors, the raw data representing a location of the tracking and monitoring unit and a health of the portable asset; (2) an asset tracking and health monitoring analysis platform in communication with the tracking and monitoring unit, the asset tracking and health monitoring analysis platform configured for receiving the raw data from the tracking and monitoring unit and executing a tracking, monitoring, and management module for analyzing the raw data according to a plurality of user-defined conditions to determine one or more corresponding outcomes; and (3) an application-linking platform in communication with the asset tracking and health monitoring analysis platform and a plurality of user devices, the application-linking platform implementing a tracking and monitoring application for: (a) receiving, via one or more interactive screens presented on the plurality of the user devices, the user-defined conditions; and (b) providing, via the one or more of the interactive screens, the corresponding outcomes.

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 provides a functional block diagram of an illustrative environment where various techniques described herein may be implemented according to some embodiments;

FIG. 2 provides a functional block diagram depicting one embodiment of a tracking and monitoring unit for placement within a portable asset of FIG. 1;

FIG. 3 provides a block diagram depicting one embodiment of an asset tracking and health monitoring analysis module of an asset tracking and health monitoring analysis platform of FIG. 1;

FIG. 4 provides a functional block diagram of one embodiment of an application-linking module of an application-linking platform of FIG. 1; and

FIGS. 5A-5DD provide a representative sampling of preconfigured and interactive screens of a graphical user interface (GUI), as presented at a user device via a GUI module of the application-linking module of FIG. 4.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

### Overview

The technology discussed herein relates to location tracking and health monitoring of portable assets, including, for example, portable storage containers, shipping containers, and cargo containers, along with their contents. Embodiments of the disclosed asset tracking, monitoring, and management system and associated use methods additionally provide asset team, fleet, and customer management solutions.

In this regard, the disclosed system and methods track an asset's location with a high level of redundancy including via GPS/Glonass, via WiFi access-point sniffing, and via cell tower triangulation to ensure consistent asset tracking despite signal fluctuations experienced through any particular medium. In addition to location tracking functionality, embodiments of the disclosed system and methods provide health monitoring relating to a variety of asset health conditions including temperature and humidity of or within the asset, shock, tilt, and detected motion within (e.g., entry or access to) the asset.

Generally, when elements discussed herein are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products or modules. Accordingly, some or all of the subject matter may be embodied in hardware and/or in software or in a combination thereof (including firmware, resident software, micro-code, state machines, gate arrays, etc.). As used herein, a software component may include any type of computer instruction or computer executable code located within or on a non-transitory computer-readable storage medium/memory. A software component may, for instance, comprise one or more physical or logical blocks of computer instructions, which may be organized as a routine, program, object, component, data structure, etc., that performs one or more tasks or implements particular data types.

Furthermore, the subject matter may take the form of a computer program product or module on a computer-usable or computer-readable storage medium/memory having computer-usable or computer-readable program code embodied in the medium for use by or in connection with an instruction execution system. In the context of this document, a computer-usable or computer-readable storage medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, computer readable media may comprise computer storage media and communication media.

Computer storage media/memory includes volatile and nonvolatile, removable and non-removable media implemented in any method or technology for storage of information such as computer readable instructions, data structures, program modules, or other data. Computer storage media includes any medium that can be used to store the desired information and that can be accessed by an instruction execution system.

Communication media typically embodies computer readable instructions, data structures, program modules, or other data in a modulated data signal such as a carrier wave or other transport mechanism and includes any information delivery media/network channel. By way of example, and not limitation, the term communication media, channel, or network includes wired media such as a wired network or direct-wired connection, and wireless media such as satellite, wireless networking technologies (e.g., WAN, WiFi, WLAN, WiMAX, NB-IoT, cellular), acoustic, RF, infrared, Bluetooth, and/or other wireless media. Combinations of the any of the above should also be included within the scope of communication media and/or channels.

When the subject matter is embodied in the general context of computer-executable instructions, the embodiment may comprise program modules or tools, executed by one or more systems, computers, processors, or other devices. Generally, program modules include routines, programs, objects, components, data structures, etc. that perform particular tasks/functions or implement particular data types. Typically, the functionality of the program modules may be combined or distributed as desired in various embodiments. Software implementations may include one or more computer programs comprising executable code/instructions that, when executed by a processor, may cause the processor to perform a method defined at least in part by the executable instructions. The computer program/module can be written in any form of programming language, including complied or interpreted languages, and can be deployed in any form, including as a standalone program or as a module, component, subroutine, or other unit suitable for use in a computing environment.

### Exemplary Embodiments

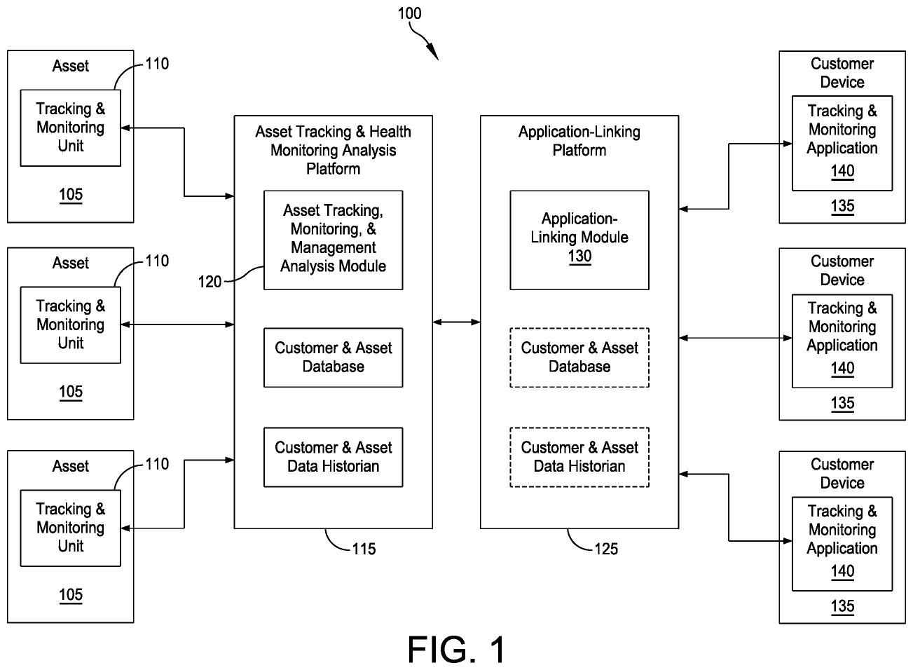

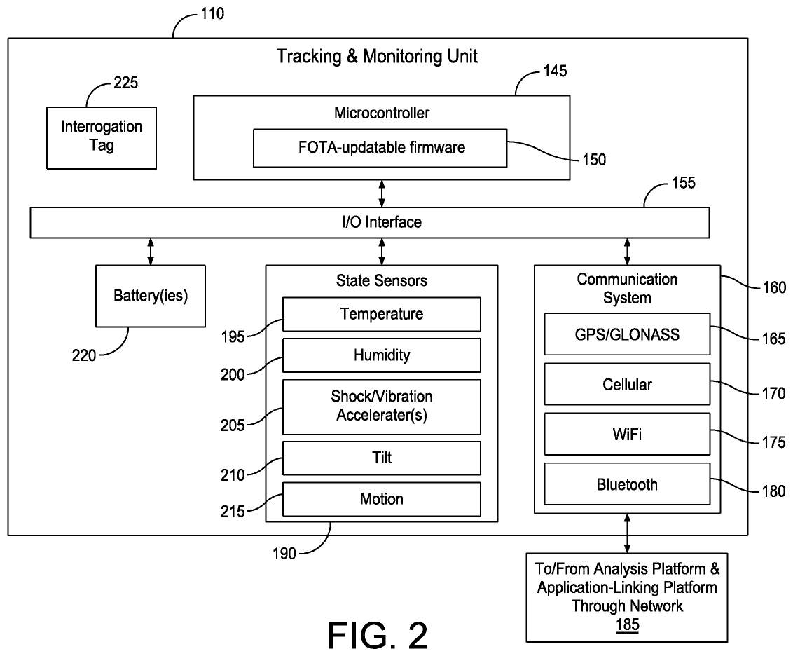

As discussed above, the present systems and methods generally relate to portable asset location tracking, asset health monitoring, and team, fleet, and customer management. Turning to the figures, FIG. 1 provides a functional block diagram 100 of an illustrative environment where various techniques described herein may be implemented according to some embodiments. As shown, one or more portable assets 105 (e.g., shipping containers, cargo containers, other portable storage containers) associated with a customer or customer team may each host a tracking and monitoring unit 110 featuring a multi-mode communication system coupled to a variety of state sensors for ongoing asset location and health monitoring, as detailed below in relation to FIG. 2.

Returning to FIG. 1, the tracking and monitoring unit 110 collects and stores raw data from the state sensors and the multi-mode communication system at pre-determined intervals according to defined customer conditions and directly transmits, for example via a 4G cell network through an onboard cell router of the multi-mode communication system, the raw data payloads to an asset tracking and health monitoring analysis platform 115 (hereinafter the “analysis platform” 110). The analysis platform 115 then processes or analyses the sensor data according to a set of condition-based algorithms of an asset tracking, monitoring, and management analysis module 120 (hereinafter the “analysis module” 120) to trigger certain outcomes including, for example, reports, alerts, notifications, and other responsive events or actions based on the data collected from the state sensors and the communication system, as analyzed by the analysis module. The analysis platform 120 may be an n-Link platform running on the Amazon Web Services (AWS) cloud and may also incorporate a storage database and a data historian for storing the raw data and data analysis results. Notably, each of the tracking and monitoring units 110 communicates directly with the analysis platform 115 in the cloud, without first pinging an intermediate control/access point operating at, with, or near a storage site or another asset location site.

In this embodiment, the analysis platform 115 may transmit or publish the data analysis results, and the raw data itself if desired and/or necessary, to an application-linking platform 125, also maintained on the AWS cloud, which receives the data and the analysis results and executes a set of algorithms of an application-linking module 130 to control system linkage with a tracking and monitoring application (e.g., a web application, iOS application, Android application) running on one or more user/customer devices 135, which may be administrative user devices or individual customer user devices and may be any network-enabled computer such as, for example, a smartphone, laptop computer, desktop computer, and the like.

The tracking and monitoring application 140 running on the user device may provide a plurality preconfigured and interactive graphical user interface (GUI) screens that enable communication through the cloud-platform chain to/from the tracking and monitoring unit for a variety of tracking, monitoring, and management purposes including, for example, access to and control of the defined customer conditions (e.g., sensor settings, communication settings, outcome thresholds and/or triggers, reporting settings, alert settings, notification settings, defining customer teams, defining assets in a fleet, etc.), the raw data, the analysis results, as well as interactive access to actual reports, alerts, triggered actions, and/or for interrogating or querying the tracking and monitoring unit directly, as further detailed below.

The functionality and components of the analysis platform 115 and the application-linking platform 125 may be separate, as described above, or may be combined in a single computing platform or distributed across a plurality of computing platforms as desired and/or appropriate in various embodiments. The distribution of processing, storage, software instructions, scripts, algorithms, and user interfaces may be distributed in any appropriate manner across any number of computing platforms that are similarly or disparately geographically situated.

To further detail the primary system components described generally above, FIG. 2 provides a functional block diagram depicting one embodiment of the tracking and monitoring unit 110. In this embodiment, the tracking and monitoring unit 110 may be a physical unit or “box” having a waterproof, dustproof, and drop proof/shock absorbent enclosure (e.g., an IP67 rated enclosure). The enclosure may encompass a microcontroller 145 running cellular FOTA-updatable firmware 150 that is customizable according to the customer's defined conditions, discussed further below. The microcontroller 145 may be communicatively coupled via an I/O interface 155 with the multi-mode communication system featuring a number of transceivers 160, which may include GPS/GLONASS transceivers 165, cellular transceivers 170, WiFi transceivers 175, and Bluetooth transceivers 180, thereby enabling a variety of location tracking and communication mediums. In some embodiments, the multi-mode communication system may be operable to provide communications through a network 185, which may include, for example, the Internet. Additionally or alternatively, the network may include wireless personal area networks, cellular networks, LAN networks, or the like. In this embodiment, the placement of the tracking and monitoring unit within the asset, or within the storage, shipping, or cargo container, may be designed to leverage the container wall to improve or amplify the antenna characteristics of the communication system transceivers for improved signal transmission to and from the unit according to Faraday's Law.

The tracking and monitoring unit 110 may also incorporate a plurality of state sensors 190 including, for example, one or more temperature sensors 195, humidity sensors 200, shock/vibration accelerometers 205, tilt sensors 210, and infrared motion detectors 215 that operate to monitor a heath of the asset and its contents in terms of heat (e.g., too hot, too cold), humidity (e.g., too high, too low), acceptable/unacceptable shock, vibration, and/or tilt levels, and motion detected within the asset (e.g., rodents, human access in/out of the asset container). The multi-mode communication system and the state sensors may collect raw data from within the asset at defined intervals for subsequent analysis and then reporting, alert, notification and/or for triggering other responsive outcomes, events, or actions according to the customer's defined conditions.

The tracking and monitoring unit 110 may be battery powered via any appropriate number and/or type of batteries 220. In one embodiment, the unit 110 may be powered by 4 AA batteries with a 20-year shelf-life and a 2-year operational life. Operational life may vary depending on the sensor and communication settings or conditions (e.g., 1 GPS reading per day, etc.) defined by the customer. The system may provide alerts via the tracking and monitoring application(s), detailed below, to warn at predetermined battery life thresholds.

In this embodiment, the tracking and monitoring unit 110 may also incorporate a physical interrogation tag 225 such as, for example, a QR code, bar code, or the like. The interrogation tag 225 is accessible to the customer or other user via the tracking and monitoring application running on the customer or user device, and the customer may employ the tracking and monitoring application and the user device (e.g., camera, QR code reader) to interrogate the interrogation tag 225 to identify, set-up, other otherwise directly communicate with, query, and/or control the tracking and monitoring unit 110.

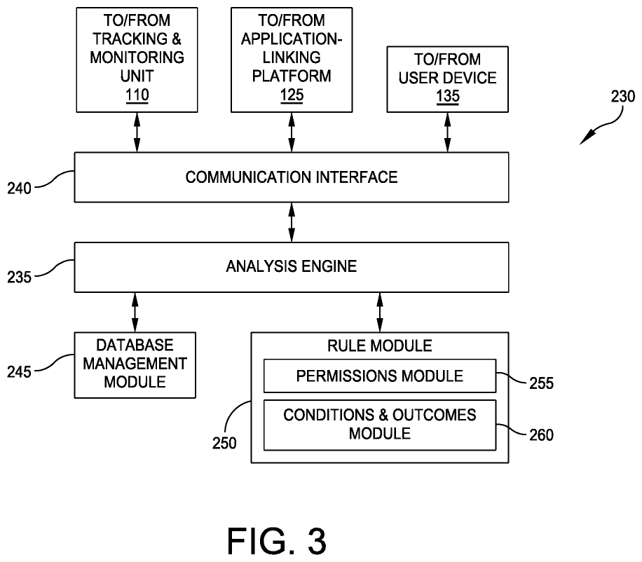

Turning to the analysis platform, FIG. 3 provides a block diagram 230 depicting one embodiment the analysis module 120 of the analysis platform 115 (illustrated in FIG. 1). In various implementations, the analysis module 120 may be stored in the analysis platform 115 and executed by processors of the analysis platform 115. The analysis module 120 may receive the raw data transmitted from the tracking and monitoring unit 110 and process or analyze the data according to a plurality of customer-defined conditions relating to the location and health of the asset.

As shown in FIG. 3, and in one embodiment, the analysis module 120 (FIG. 1) may include an analysis engine 235 coupled to a communication interface 240, a database management module 245, and a rule module 250. In operation, the communication interface 240 may enable the analysis engine 235 to exchange information with other system components such as the tracking and monitoring units 110 (FIG. 1), the application-linking platform 125 (FIG. 1), and the user devices 135 (FIG. 1). In some embodiments, the communication interface 240 may be configured to transmit and/or receive information using JSON packets. Additionally or alternatively, other connections may also be used, such as, for example, secure socket layer (SSL) encryption, XML file transmission utilizing file transfer protocol (FTP), hypertext transfer protocol (HTTP) POST transactions, or other data transmission protocols. The communication interface 240 may further include any of a variety of standardized application programming interfaces (APIs) configured to allow different software programs to communicate (e.g., to request services and respond to such requests) in an autonomous, web-based, and/or platform-independent manner. For example, the microprocessor at the tracking and monitoring unit 110. (FIG. 1) may expose certain location or sensor data (e.g., a GPS location of the asset, a temperature with the asset, a humidity within the asset) via a web services interface. The communication interface 240 of the analysis module 120 (FIG. 1) may then access the exposed data and/or functions via the appropriate API(s) for further processing and/or analysis.

The database management module 245 (FIG. 3) may include any suitable database management system (DBMS) or application configured to manage the creation, maintenance, and use of the customer and asset database and data historian of FIG. 1.

The rule module 250 (FIG. 3) may include one or more sets of rules, in any suitable format, that facilitate the provision of location tracking, health monitoring, and team, fleet, and/or customer management functionalities. In one embodiment, the rule module 250 may include a permissions module 255 and a conditions and outcomes module 260. The permissions module 255 may comprise conditions relating to or defining access and available features for each individual user or type/level of user and/or defining a user hierarchy for implementation of the tracking and monitoring application across web and/or mobile (iOS and Android) platforms. For example, the system may implement the tracking and monitoring application as a web-based application for administrative purposes as an admin portal and as a mobile application (iOS and Android applications) that is customer driven, featuring customized access and features for each team and/or individual user. The permissions module 255 may set forth parameters to link multiple individual users as a customer team, to link multiple assets as a fleet, and define access and control for the entire team or subsets thereof.

The conditions and outcomes module 260 (FIG. 3) may define a number of customized customer or user defined conditions, triggers, and/or thresholds that act as a basis of the condition-based analysis of the analysis module 120 (FIG. 1), discussed above, and that when applied to the raw data collected at the tracking and monitoring unit 110, result in certain outcomes or actions. For example, the conditions and outcomes module 260 (FIG. 3) may define conditions and outcomes related to location tracking, including a frequency of GPS readings, WiFi access point sniffing, and/or cell tower triangulation, mapping guidelines, cluster mapping guidelines, and/or parameters for establishing a geofence about the asset (e.g., 1000 feet), along with thresholds that trigger location tracking outcomes such as requiring location reporting at certain intervals (e.g., 1 time/day), providing alerts upon defined location changes such as the asset moving outside an established geofence perimeter, arriving at a defined destination, or after a defined number of assets have clustered at a defined location. The conditions and outcomes module 260 may also define conditions and outcomes relating to the health of the asset including, for example, defining high and low temperature and/or humidity thresholds to trigger reporting, alerts, and/or notifications, defining shock, vibration, and/or tilt thresholds to trigger reporting, alerts, and/or notifications and defining reporting parameters for motion detected within the asset such as a detected customer entry or rodent invasion.

Conditions and outcomes may also be defined for the health of the tracking and monitoring unit 110 (FIG. 1) itself such as, for example, defining a low battery-life threshold to trigger an alert or reduced functionality, defining sensor health parameters to trigger alerts if/when sensors malfunction. The conditions and outcomes module 260 (FIG. 3) may also include conditions relating to team, fleet, and/or customer management including conditions that link numerous tracking and monitoring devices 110 (FIG. 1) together (e.g., by an associated vehicle number, plate, or registration) to form a fleet such that a user or a team of users may monitor the location and health of the fleet.

In sum, the conditions and outcomes module 260 (FIG. 3) may include customized customer conditions and defined outcomes to address a vast array of location tracking, health monitoring, and team, fleet, and customer management concerns, limited only by the raw data that may be gathered by the tracking and monitoring unit 110 (FIG. 1). Reporting and alerts may be provided through the tracking and monitoring application in any appropriate manner or configuration (e.g., yellow for a watch, red for a warning) and may trigger notifications outside the application including, pushed emails, texts, and/or calls.

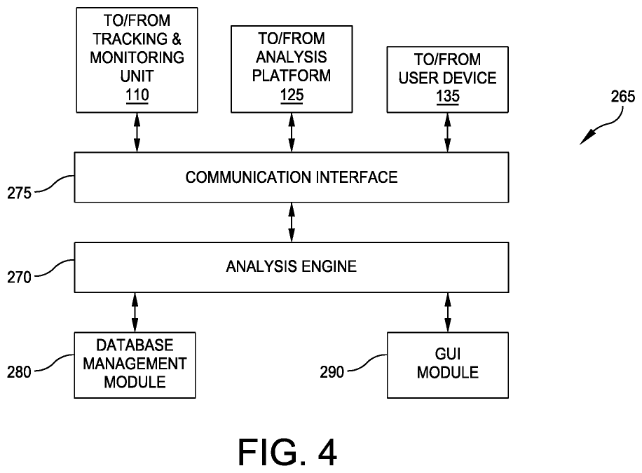

Turning to the application-linking platform 125 (FIG. 1), FIG. 4 provides a functional block diagram 265 of one embodiment of the application-linking module of the application-linking platform 125 (FIG. 1). The application-linking module 130 may be similar in structure to the analysis module 120 (FIG. 1) of the analysis platform 115 (FIG. 1), discussed above in relation to FIG. 3. In this embodiment, the analysis engine 270 may couple to a communication interface 275. The communication interface 275 may enable the analysis engine 270 to exchange information with other system components such as the tracking and monitoring units 110 (FIG. 1), the application-linking platform 125 (FIG. 1), and the user devices 135 (FIG. 1). Analysis engine 270 may communicate with a database management module 280 and a GUI module 285 configured to provide, for example, a mobile application interface or a web-based user interface (WUI) that implements JAVA®, AJAX®, ADOBE FLEX®, MICROSOFT .NET®, or similar technologies to provide real-time user control. In various embodiments, a GUI may be displayed to a user via the GUI module. The GUI may be operable to display information and/or receive commands from the user at the user device. In various implementations, the GUI may be displayed, via any number of appropriate preconfigured and interactive screens, to a user operating a customer user device or an administrative user device. For example, the GUI module may display one or more preconfigured screens at the customer user device to report on an asset's location each day, to provide an alert when the asset strays from a defined geofence perimeter, or to provide an ongoing reporting graph reflecting a temperature with an asset. Alternatively, the GUI module may display one or more preconfigured screens at an administrative user device to, for example, set-up and define a team or to connect the tracking and monitoring units associated with multiple assets to form a fleet assigned to that team.

A browser or application window at any of the user devices may be configured to display text content, image content, input features, navigable links, etc. of the preconfigured screens of the GUI. Each preconfigured screen may include any appropriate type of content in various combinations, and the screen(s) displayed to the users may be specific to the viewing platform. For example, screen(s) presented at the administrative user device may differ from the screen(s) shown at a first set of customer user devices for an assigned team or fleet, which may differ from the screens shown another set of customer user devices for another assigned team or fleet, depending on a variety of factors including, for example, the type of information to be collected and/or transmitted, security concerns, user permissions, defined conditions and outcomes, and so on.

GUI screen content may be interspersed or combined in any suitable fashion according to the capabilities of the browser and/or language used to implement the GUI, and may be displayed in any suitable area of the browser or application window. In some embodiments, the window may be generated and managed by a web browser such as, for example, MICROSOFT EXPLORER®, FIREFOX®, SAFARI®, CHROME®, etc., implemented from the appropriate system component.

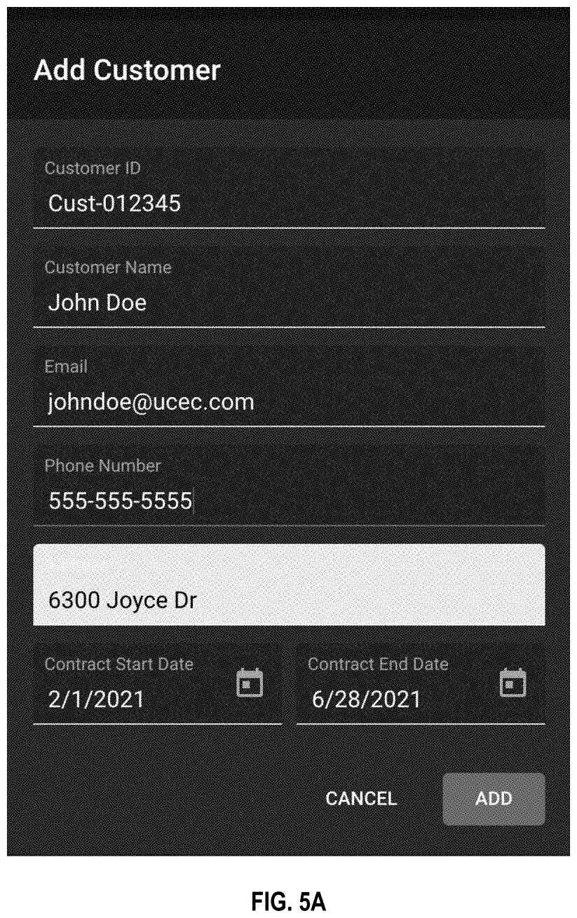

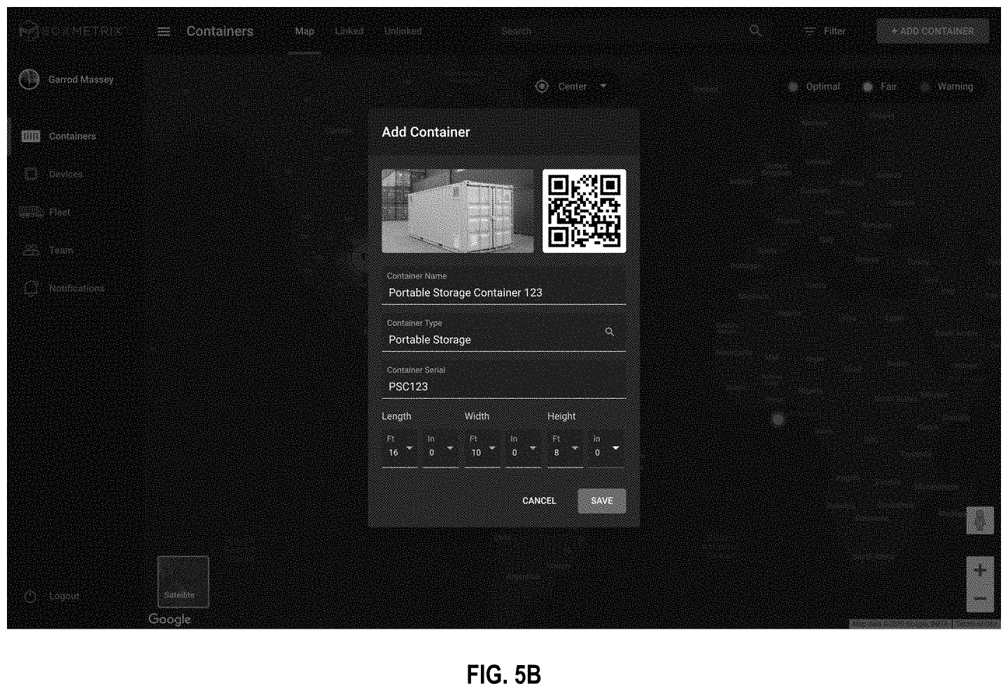

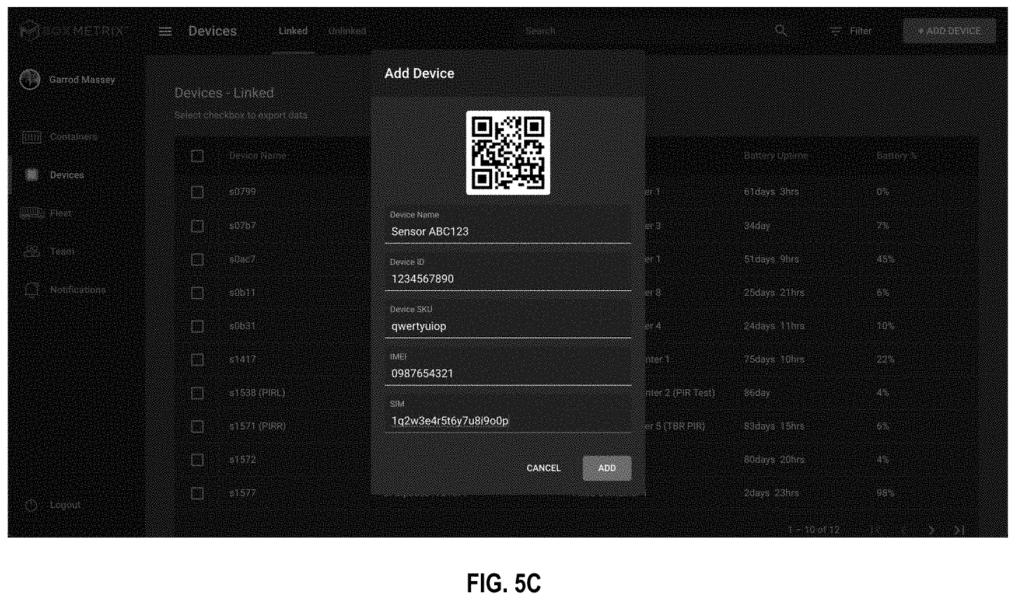

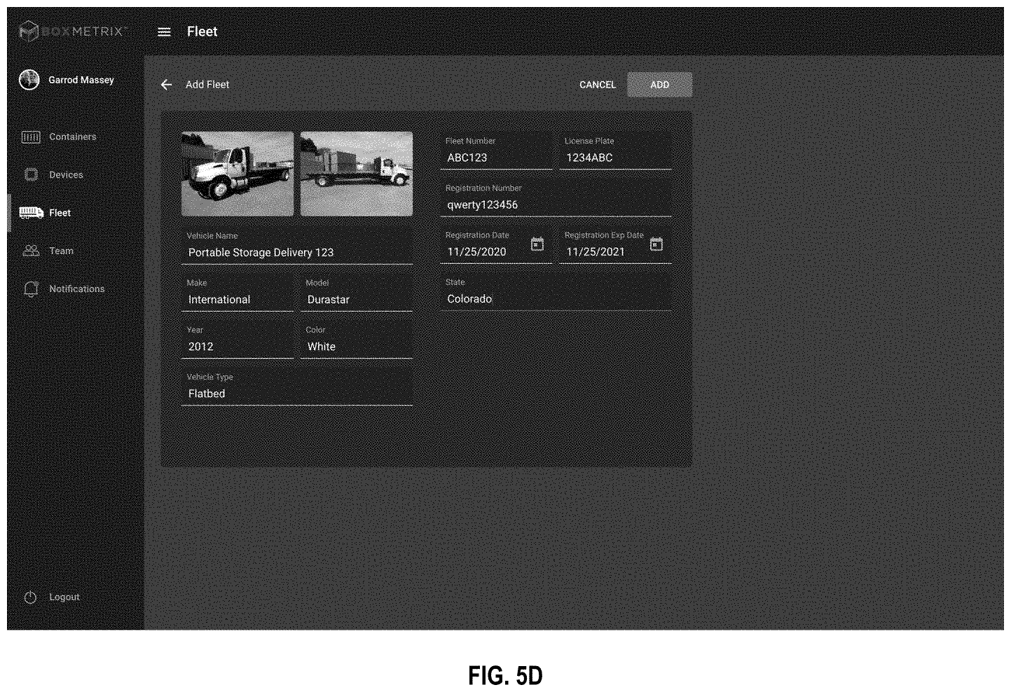

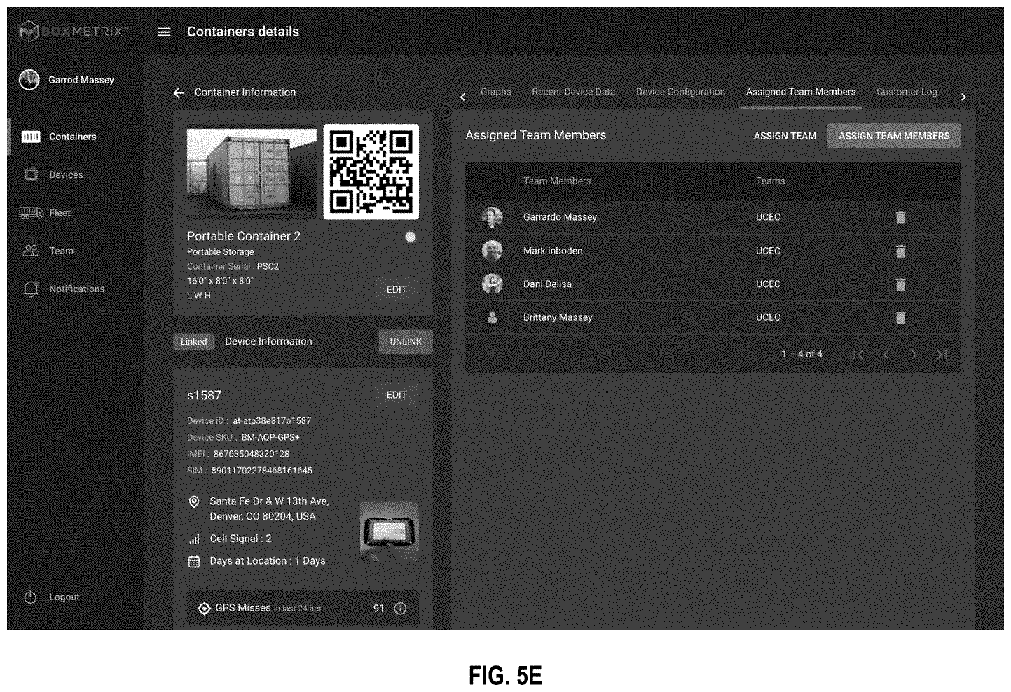

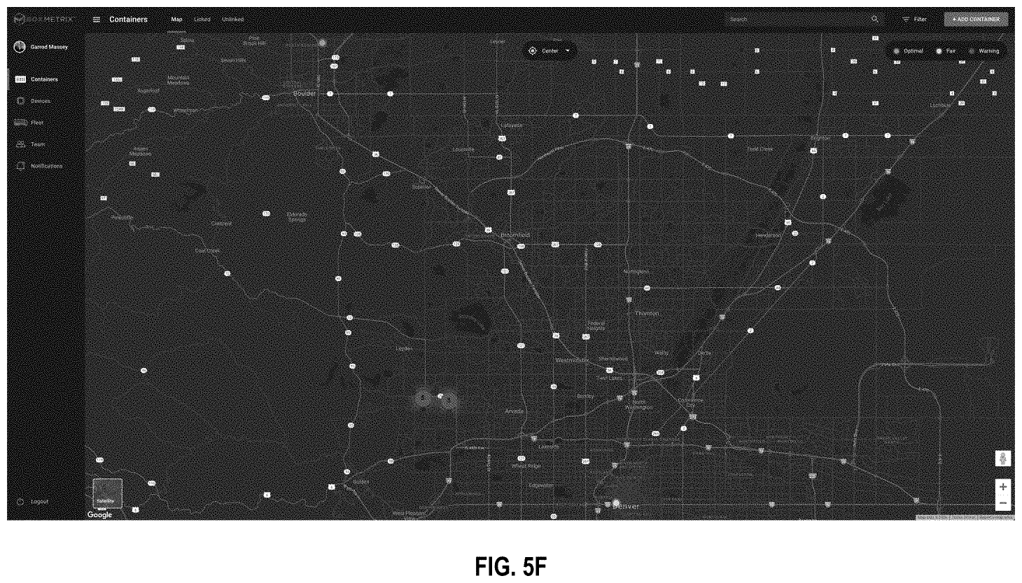

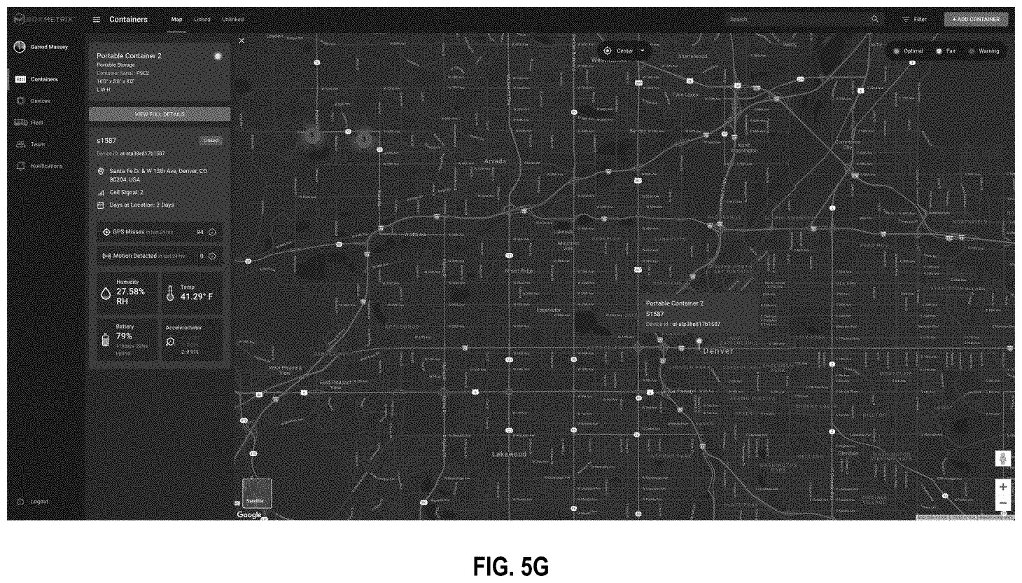

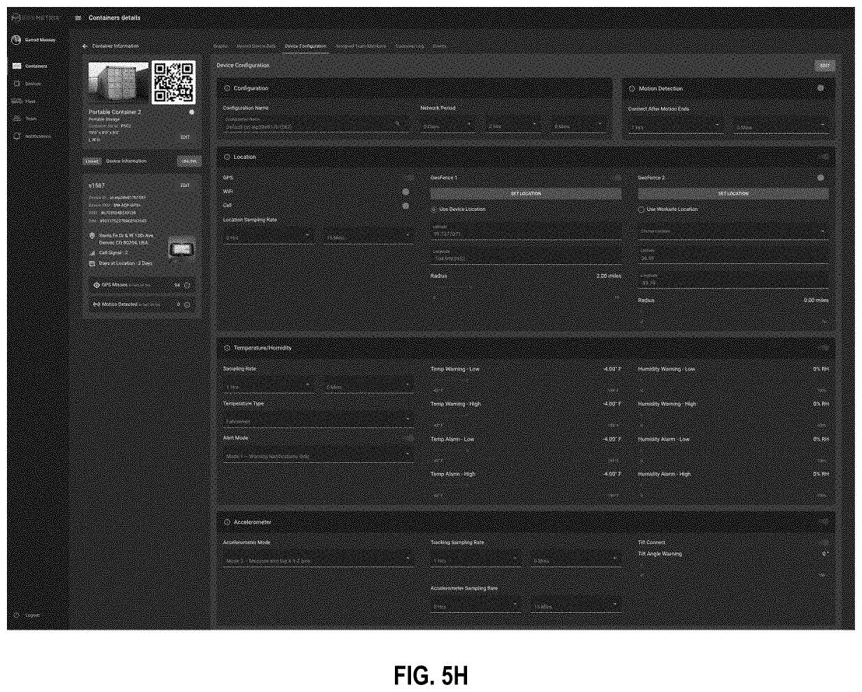

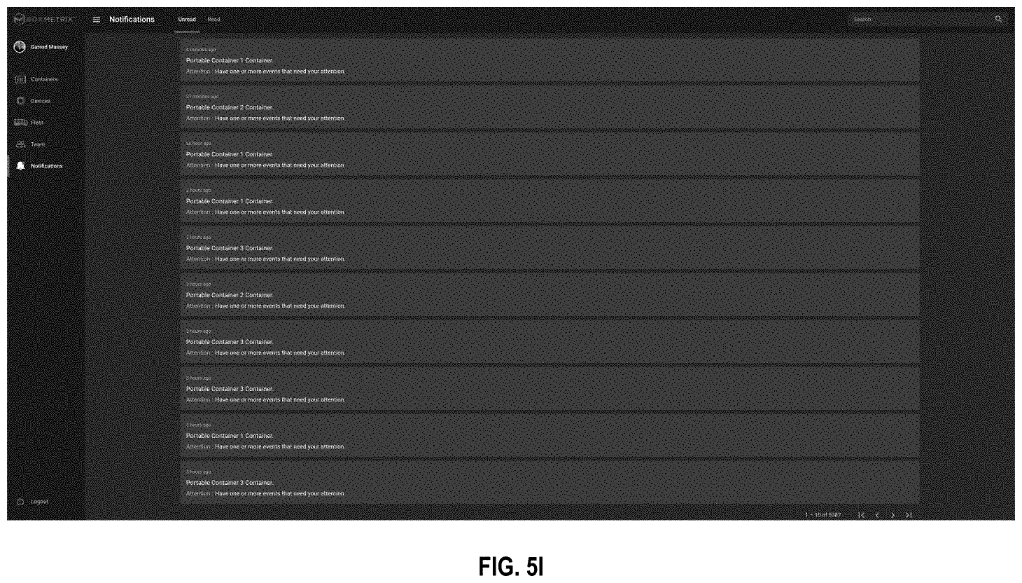

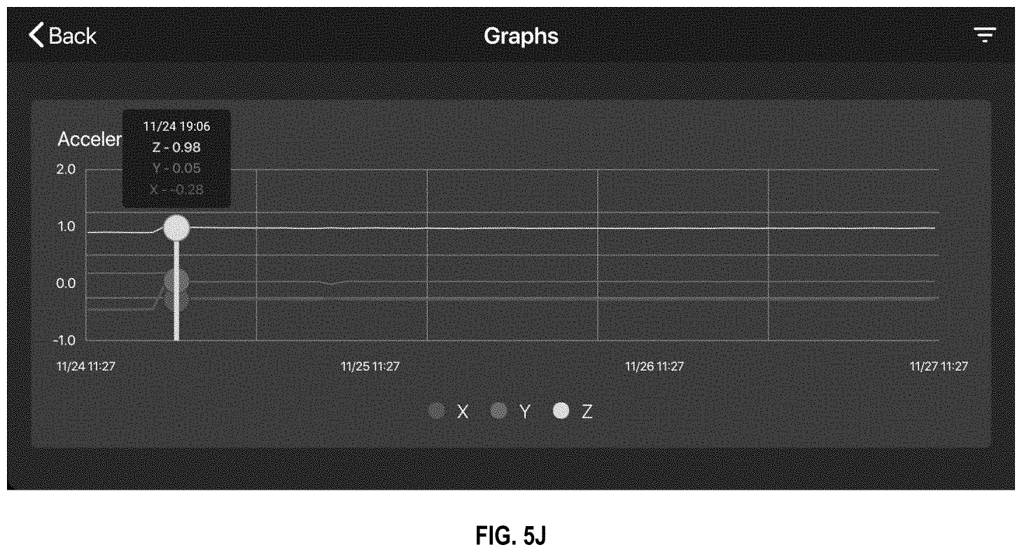

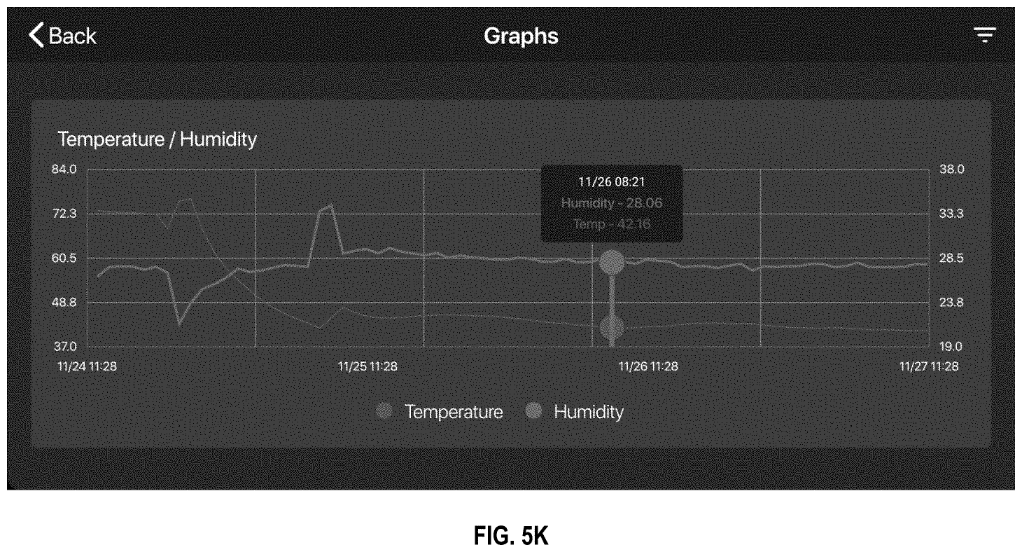

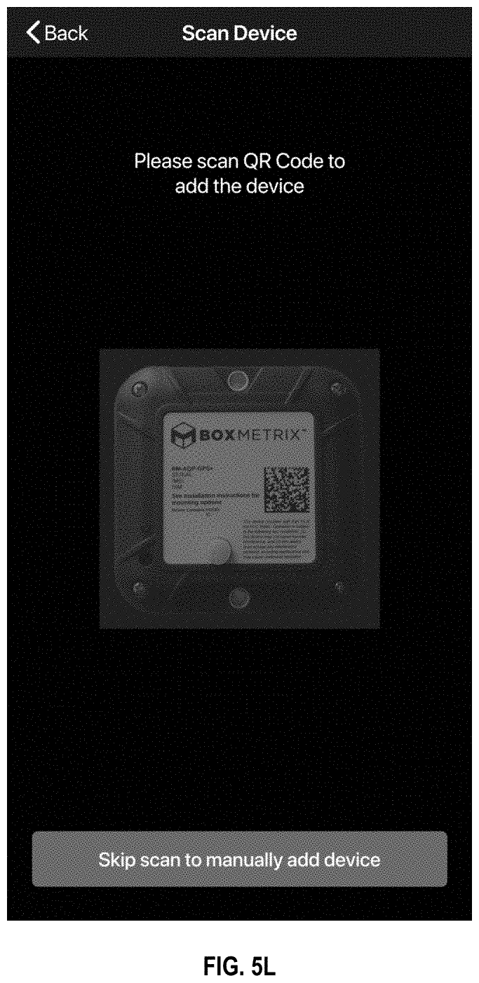

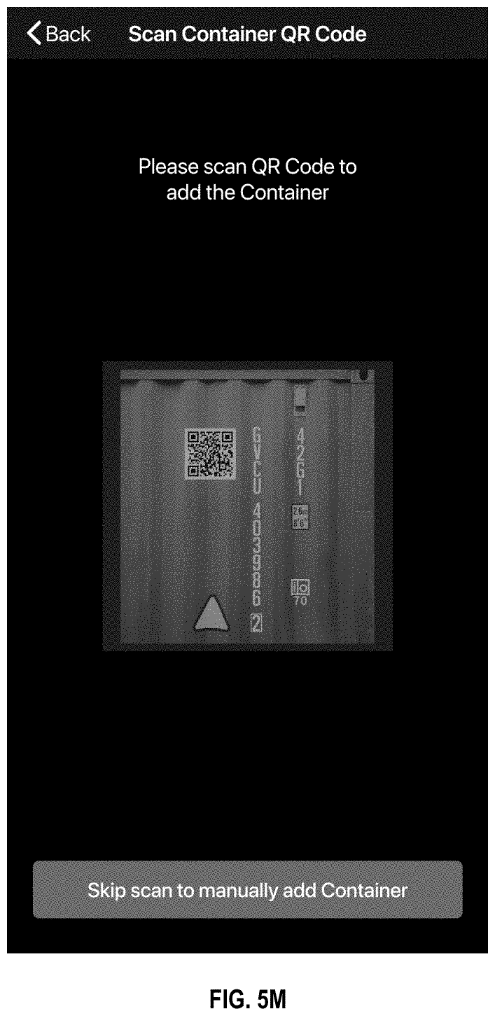

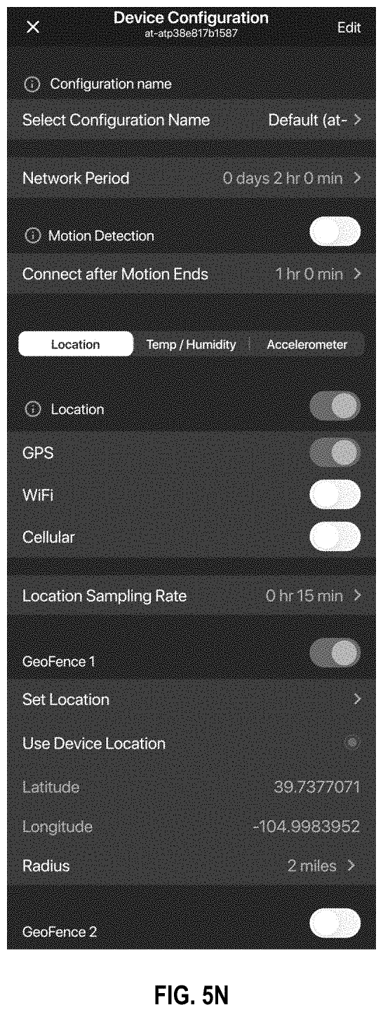

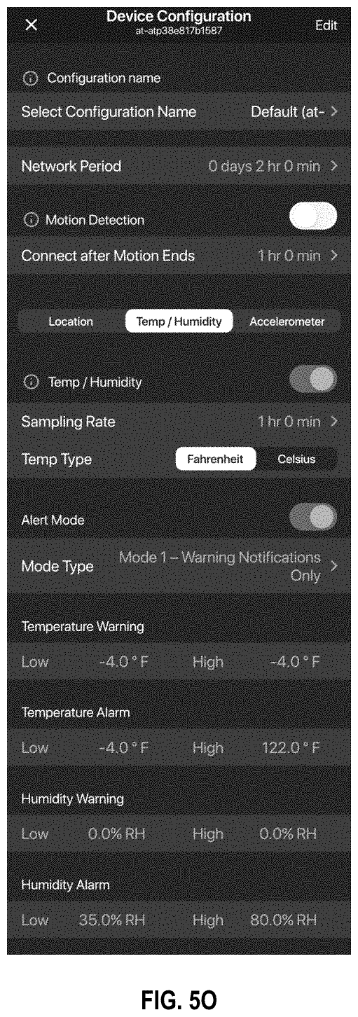

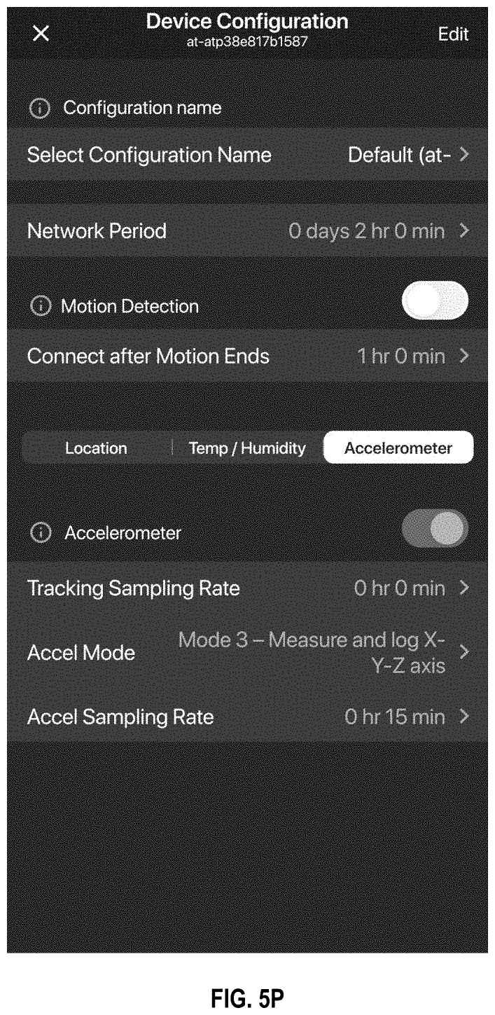

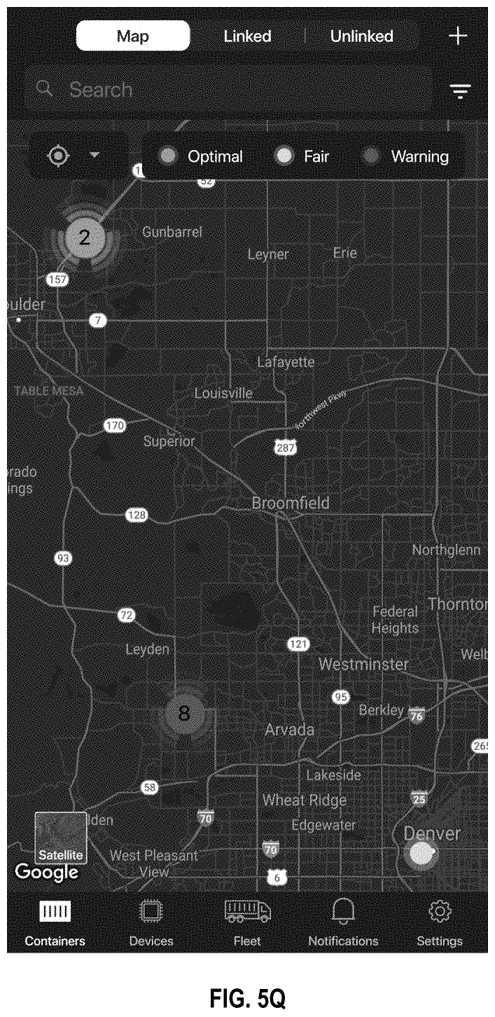

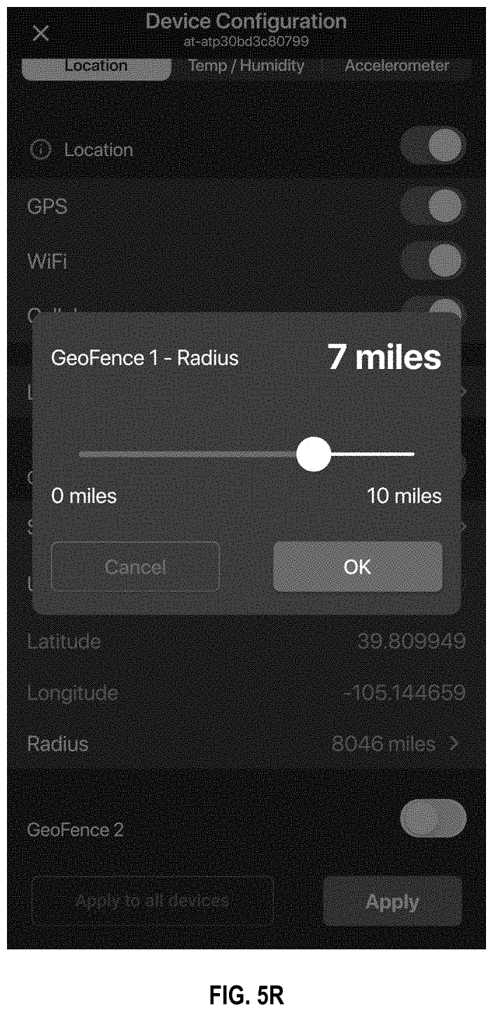

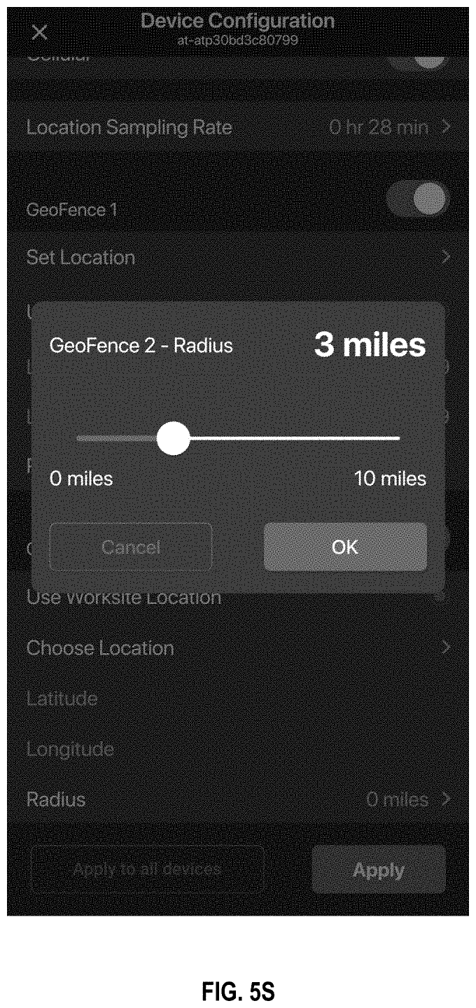

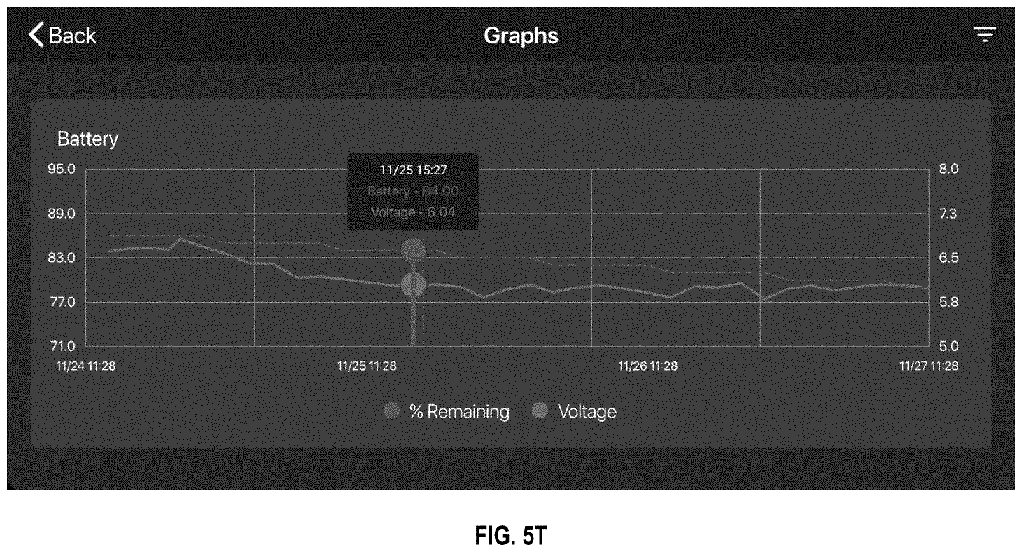

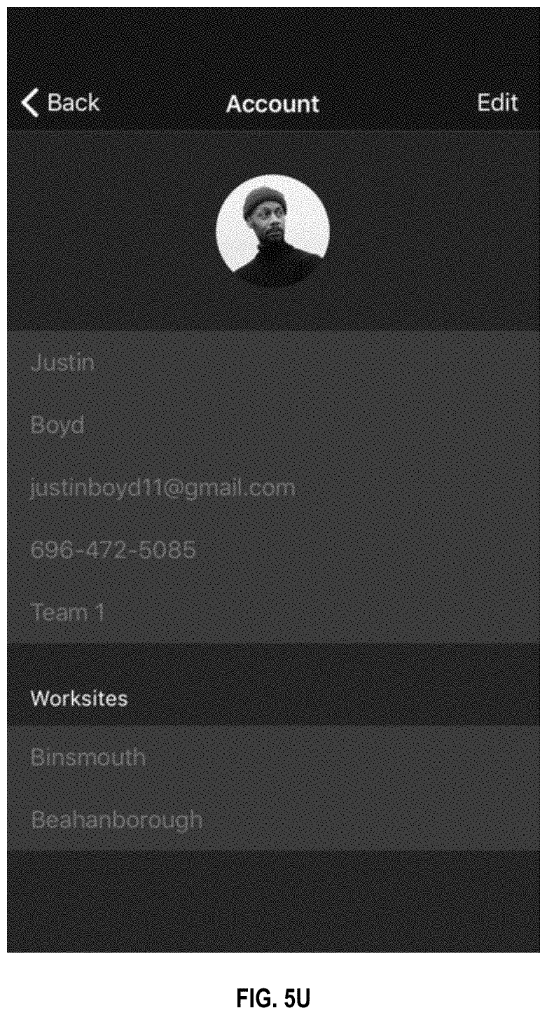

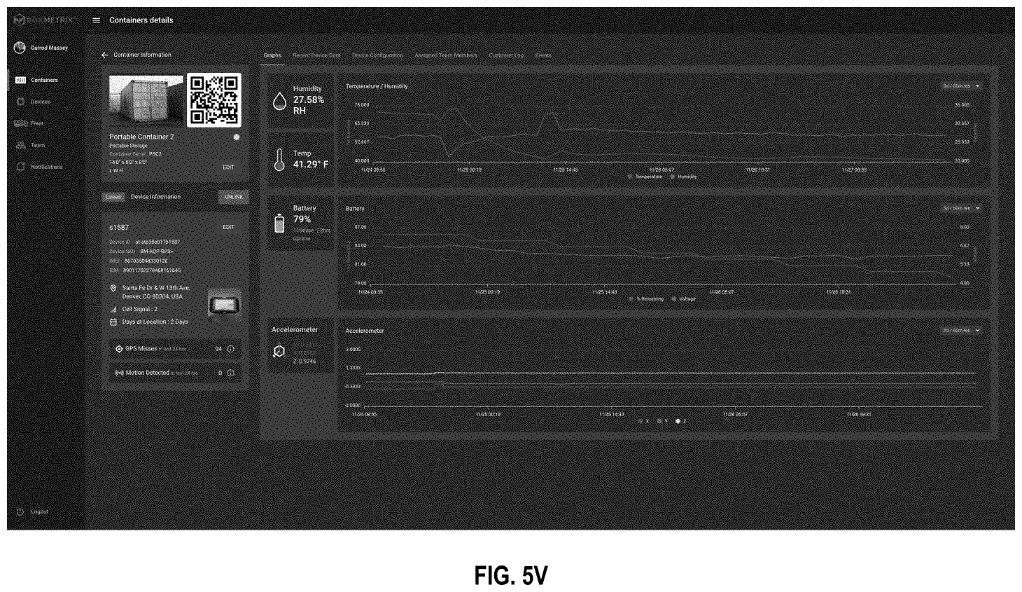

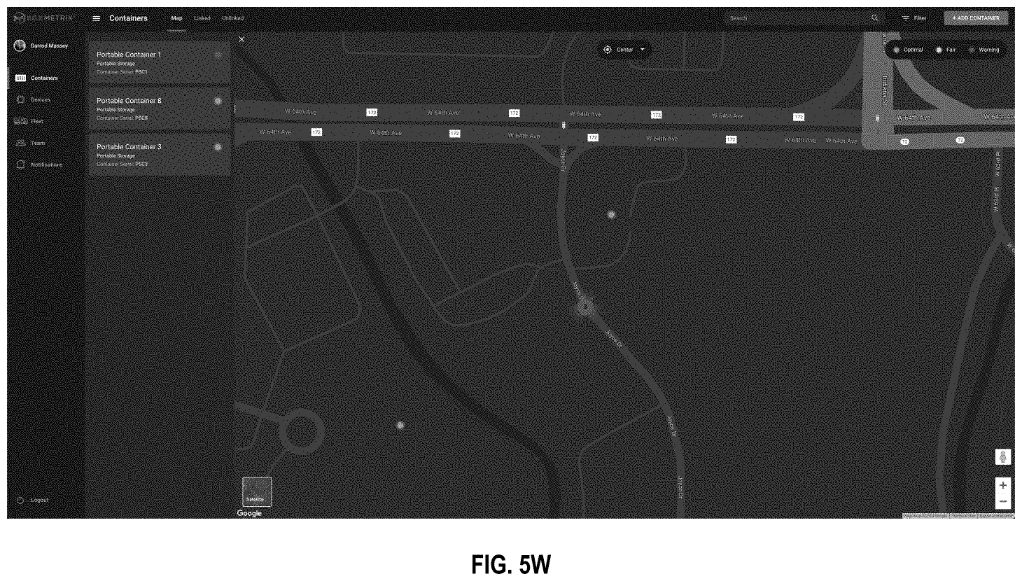

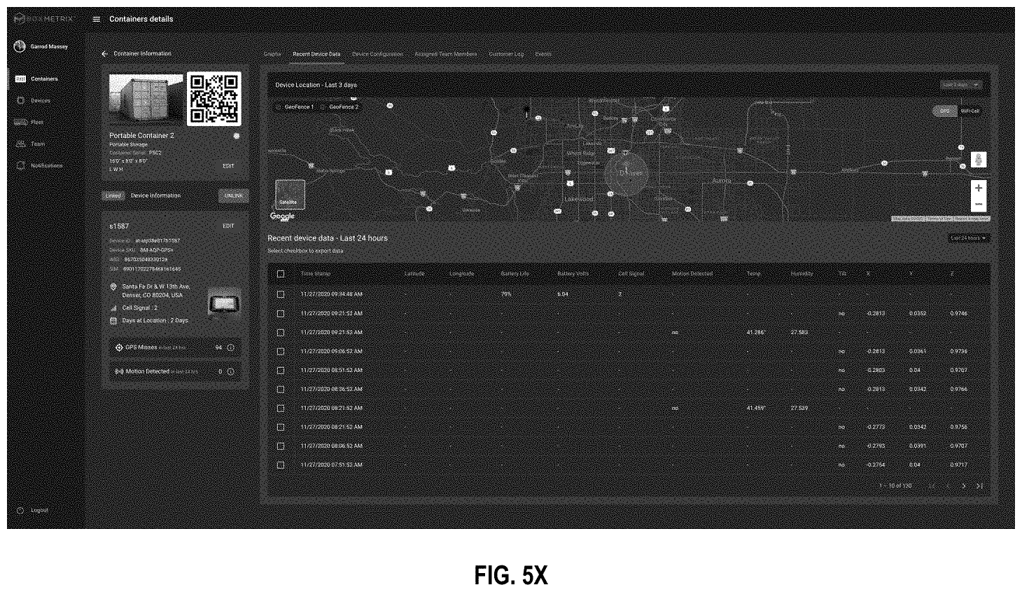

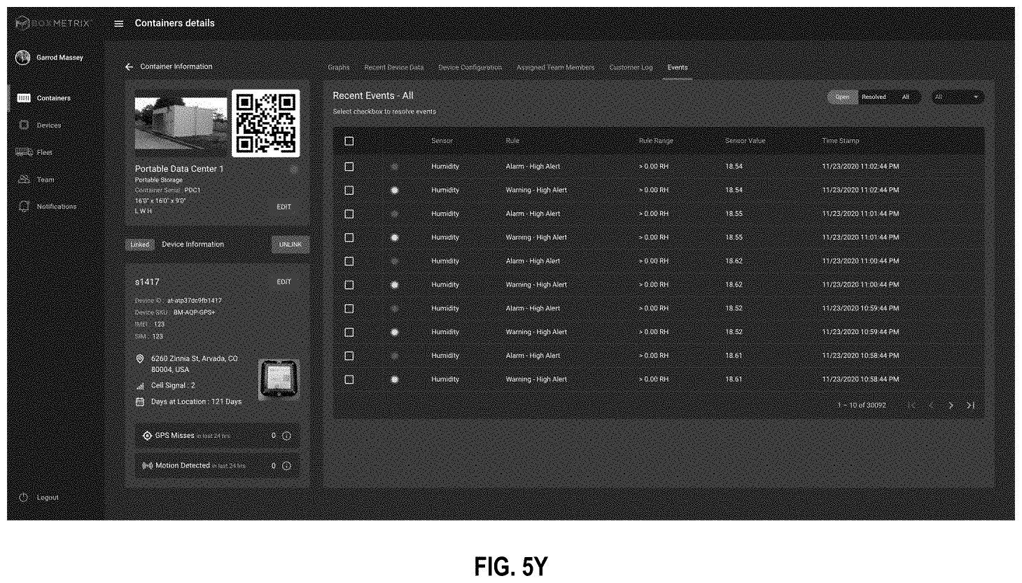

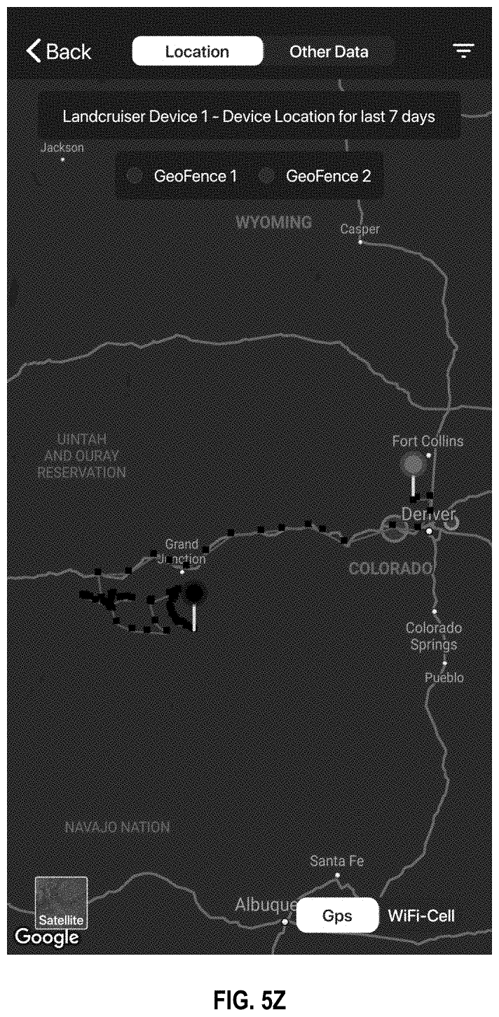

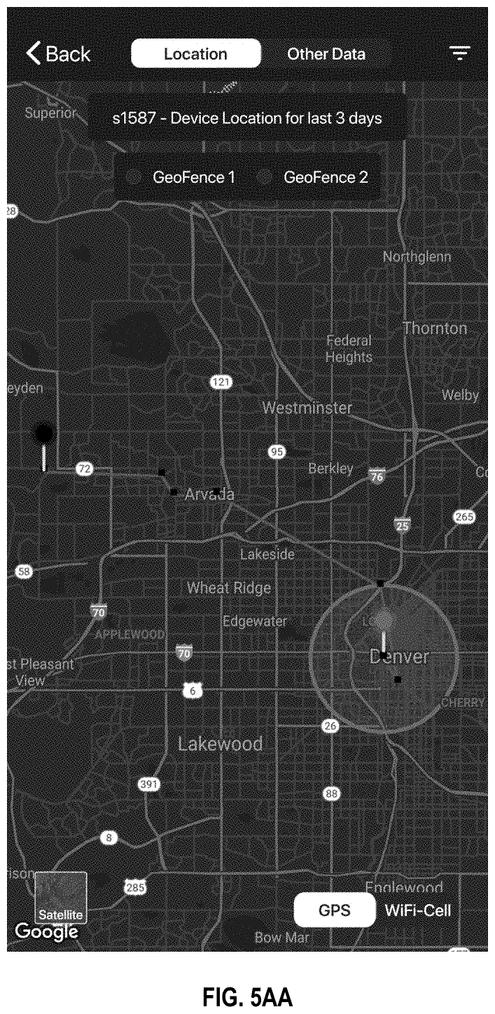

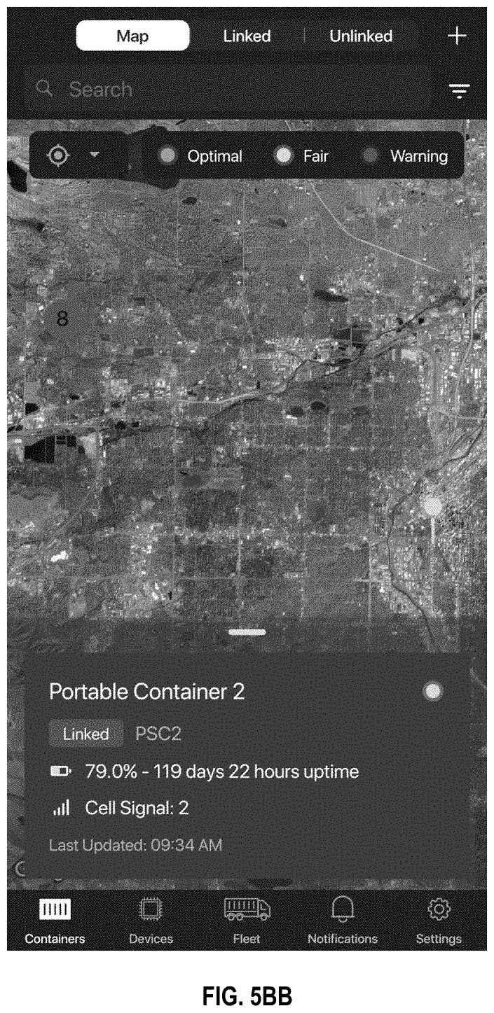

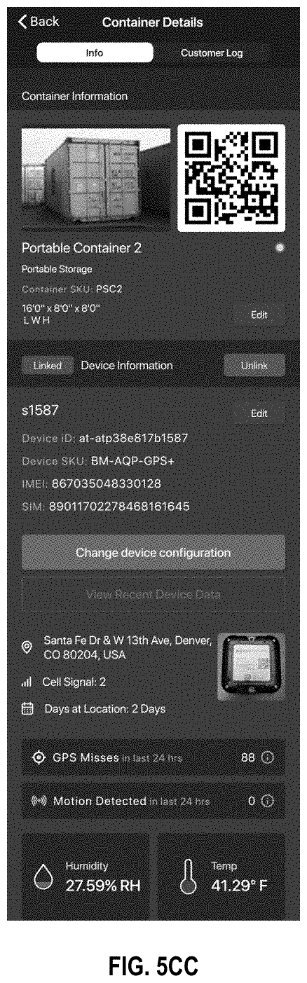

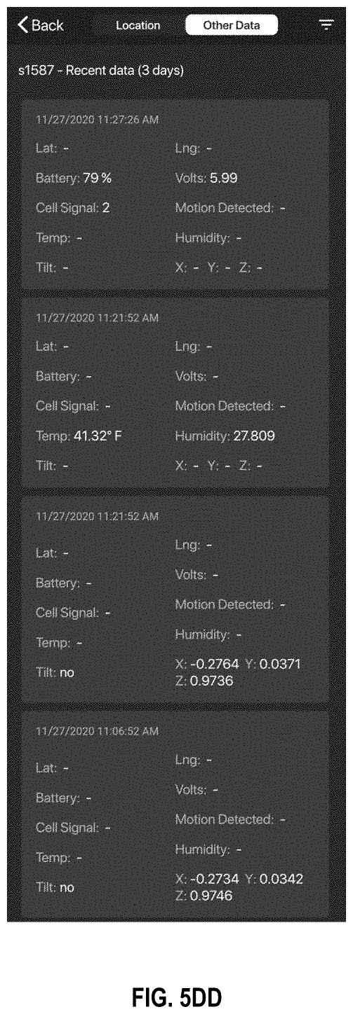

FIGS. 5A-5DD provide a representative sampling of preconfigured and interactive screens of the GUI, as presented at the user device via the GUI module. More specifically, FIGS. 5A-5I illustrate exemplary administrative screens that may, for example, be presented by the GUI module via a web-based implementation of the tracking and monitoring application including preconfigured, interactive screens for adding a customer user, adding an asset container, adding a tracking and monitoring unit, defining a fleet, assigning team members to a group, mapping container clusters, configuring a tracking and monitoring unit, and receiving notifications associated with tracking and monitoring units, respectively.

FIGS. 5J-5U illustrate exemplary user screens that may, for example, be presented by the GUI module via a mobile-application (e.g., iOS or Android) implementation of the tracking and monitoring application including preconfigured, interactive screens for monitoring tracking and monitoring unit sensors (e.g., an accelerometer), scanning a tracking and monitoring unit interrogation tag (e.g., QR code) to add the tracking and monitoring unit, configuring a tracking and monitoring unit's settings, tracking/mapping asset locations, providing notifications or alerts (e.g., geofence, radius from defined location), monitoring battery usage at the tracking and monitoring unit, and defining customer user settings, respectively.

FIG. 5V illustrates an exemplary application screen for composite functions including location tracking, mapping, and health monitoring of the asset via the multi-mode communication system and the state sensors of the tracking and monitoring unit (e.g., humidity and temperature graph, battery life, accelerometer graph, days at location).

In various embodiments, the modules shown in FIGS. 1-4 may represent sets of software routines, logic functions, and/or data structures that are configured to perform specified operations. Although these modules are shown as distinct logical blocks, in other embodiments, at least some of the functionality provided by these modules may be combined into fewer blocks or parceled into additional blocks. Conversely, any given one of the modules may be implemented such that its functionality is divided among two or more logical blocks. Moreover, although shown with a particular configuration, in other embodiments these various modules may be rearranged in other suitable ways.

Embodiments of the asset tracking, monitoring, and management system discussed above enable a variety of asset tracking methods, asset health monitoring methods, and team, fleet, customer management methods that allow customers to install tracking and monitoring units into one or more assets, add the tracking and monitoring units to a fleet, link users together as a customer team, track the location of the asset or fleet of assets in a variety of customized ways (e.g., mapping, geofencing, duration-at-location reporting, real-time movement tracking), monitor a health of the asset or assets in relation to temperature, humidity, tilt, vibration, shock, motion within the asset, and battery life of the tracking and monitoring units, and manage the team of users, associated fleet of assets, and individual customers using the system.

Embodiments of the systems and methods disclosed herein enable multi-mode or medium location tracking of assets with a higher level of redundancy than existing systems, which generally fail with signal losses. The system also allows a high degree of customization, via the tracking and monitoring unit firmware and the tracking and monitoring application, and enables customized thresholds and triggers for outcomes such as alerts, reporting, and action. This customizability exists across at least ten supported functionalities of the system: cellular, WiFi, GPS, Bluetooth, temperature sensing, humidity sensing, shock sensing, tilt sensing, motion sensing, and FOTA over-air firmware updates. With NB-IOT and Cat1M 4G LTE network connectivity, assets equipped with the tracking and monitoring unit may roam anywhere in the world for maximum reach in asset tracking, health monitoring, and fleet management.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A system for tracking a location and monitoring a health of a portable asset, the system comprising:
a tracking and monitoring unit affixed to the portable asset, the tracking and monitoring unit comprising an enclosure housing a microcontroller communicatively coupled with a plurality of state sensors, an interrogation tag, and a multi-mode communication system including a plurality of communication transceivers, the microcontroller configured for collecting raw data from the multi-mode communication system and the plurality of the state sensors, the raw data representing a location of the tracking and monitoring unit and a health of the portable asset;
an asset tracking and health monitoring analysis platform in communication with the tracking and monitoring unit, the asset tracking and health monitoring analysis platform configured for receiving the raw data from the tracking and monitoring unit and executing a tracking, monitoring, and management module for analyzing the raw data according to a plurality of user-defined conditions to determine one or more corresponding outcomes; and
an application-linking platform in communication with the asset tracking and health monitoring analysis platform and a plurality of user devices, the application-linking platform implementing a tracking and monitoring application for:
receiving, via one or more interactive screens presented on the plurality of the user devices, the user-defined conditions; and
providing, via the one or more of the interactive screens, the corresponding outcomes.

2. The system of claim 1, wherein the portable asset comprises a shipping container, a cargo container, or a portable storage container.

3. The system of claim 1, wherein the plurality of the communication transceivers of the multi-mode communication system comprise a cellular transceiver, a WiFi transceiver, a GPS transceiver, and a Bluetooth transceiver.

4. The system of claim 1, wherein the plurality of the state sensors comprises at least two of: temperature sensors, humidity sensors, accelerometers, tilt sensors, and motion detectors.

5. The system of claim 1, wherein the one or more corresponding outcomes comprises one or more of a status report, a tracking map, an alert, and an alarm.

6. The system of claim 1, wherein a wall of the portable asset amplifies one or more signals of the multi-mode communication system.

7. The system of claim 1, wherein the interrogation tag comprises a QR code or a bar code.

8. The system of claim 1, wherein the tracking and monitoring unit further comprising one or more batteries.

9. The system of claim 1, wherein the user devices are selected from smartphones, laptop computers, and desktop computers.

10. The system of claim 1, wherein the tracking and monitoring unit are placed within or on the exterior of the asset in a configuration to leverage a container wall of the asset to improve antenna characteristics of the communication transceivers for improved signal transmission to and from the asset in accordance with Faraday's Law.

11. A method of tracking a location and monitoring a health of a portable asset, the method comprising:
providing a tracking and monitoring unit affixed to the portable asset, the tracking and monitoring unit comprising an enclosure housing a microcontroller communicatively coupled with a plurality of state sensors, an interrogation tag, and a multi-mode communication system including a plurality of communication transceivers;
collecting raw data, with the microcontroller, from the multi-mode communication system and the plurality of the state sensors, the raw data representing a location of the tracking and monitoring unit and a health of the portable asset;
providing an asset tracking and health monitoring analysis platform in communication with the tracking and monitoring unit;
receiving the raw data, with the asset tracking and health monitoring analysis platform, from the tracking and monitoring unit;
analyzing the raw data, by executing a tracking, monitoring, and management module, according to a plurality of user-defined conditions to determine one or more corresponding outcomes;
providing an application-linking platform in communication with the asset tracking and health monitoring analysis platform and a plurality of user devices;
implementing a tracking and monitoring application, the application-linking platform, by:
receiving, via one or more interactive screens presented on the plurality of the user devices, the user-defined conditions; and
providing, via the one or more of the interactive screens, the corresponding outcomes.

12. The method of claim 11, wherein the portable asset comprises a shipping container, a cargo container, or a portable storage container.

13. The method of claim 11, wherein the plurality of the communication transceivers of the multi-mode communication system comprise at least two of a cellular transceiver, a WiFi transceiver, a GPS transceiver, and a Bluetooth transceiver.

14. The method of claim 11, wherein the plurality of the state sensors comprises at least two of: temperature sensors, humidity sensors, accelerometers, tilt sensors, and motion detectors.

15. The method of claim 11, wherein the one or more corresponding outcomes comprises one or more of a status report, a tracking map, an alert, and an alarm.

16. The method of claim 11, wherein a wall of the portable asset amplifies one or more signals of the multi-mode communication system.

17. The method of claim 11, wherein the interrogation tag comprises a QR code or a bar code.

18. The method of claim 11, wherein the tracking and monitoring unit further comprising one or more batteries.

19. The method of claim 11, wherein the user devices are selected from smartphones, laptop computers, and desktop computers.

20. The method of claim 11, further comprising placing the tracking and monitoring unit within the asset in a configuration to leverage a container wall of the asset to improve antenna characteristics of the communication transceivers for improved signal transmission to and from the asset in accordance with Faraday's Law.
